(19) United States
(12) Patent Application Publication
(10) Pub. No.: US 2018/0230850 A1
(43) Pub. Date: Aug. 16, 2018

(54) A PULSE-SEPARATED AXIAL TURBINE STAGE WITH RADIAL-AXIAL INLET GUIDE VANES

(71) Applicant: BorgWarner Inc., Auburn Hills, MI (US)

(72) Inventors: Sascha KARSTADT, Undenheim (DE); Thomas BIESINGER, Mainz (DE); Georg KROEGER, Cologne (DE); Ulrich SILLER, Bornheim (DE)

(21) Appl. No.: 15/750,549

(22) PCT Filed: Aug. 1, 2016
(86) PCT No.: PCT/US2016/044994

§ 371 Date: Feb. 6, 2018

Related U.S. Application Data
(60) Provisional application No. 62/202,200, filed on Aug. 7, 2015.

(51) Int. Cl. F01D 17/16; F02B 37/24

(52) U.S. Cl. CPC F01D 17/162; F05D 2250/51; F05D 2220/40; F02B 37/24

(57) ABSTRACT

A turbocharger with at least one axial turbine stage. Separate circumferential sections of the turbine are fed by separate exhaust system runners. The turbine is designed to harness pulse energy. Corresponding engine having cylinders comprising such a turbocharger.

### BACKGROUND OF THE INVENTION

### Field of the Invention

The invention concerns a turbocharger with at least one axial turbine stage. Separate circumferential sections of the turbine are fed by separate exhaust system runners, The turbine is designed to harness pulse energy.

### Description of the Related Art

The turbine of a turbocharger is designed to extract energy from a high pressure and high temperature exhaust gas stream and therewith drive a compressor. There are two main turbine designs: radial flow, in which exhaust gases are directed radially against turbine blades, and axial flow, in which exhaust gasses are directed through a turbine wheel in a generally axial direction.

Radial turbines have been preferred in passenger car and commercial diesel applications because the efficiency of small radial-flow turbines is higher than comparable-size axial flow turbines. The exhaust gas stream flows into a circumferential volute in the turbine housing, which forms a narrowing spiral adapted turn the exhaust gas inwardly around the axis of rotation. The turbine wheel is provided with a backwall, i.e., hub that is shaped to change the direction of flow of exhaust gas from radial inflow towards an axial outlet.

Disadvantageously, the radial flow turbine wheel backwall adds to the weight of the turbine wheel, and this increase in inertia decreases the responsiveness of the turbine wheel. Further, as the backwall forces the exhaust gas to change direction in flow from a radial direction to an axial direction, the turbine wheel experiences an axial push-back in addition to surrounding pressure forces, requiring thrust bearings to accommodate the axial thrust load.

An axial flow turbine wheel, in comparison, having no back wall, has less mass and a lower moment of inertia. The turbine wheel can “spin up” more rapidly on demand. Further, since the turbine housing and not the turbine wheel is used to change the direction of flow, pressure forces including the axial thrust associated with turning the flow in the radial turbine are not present in the axial turbine rotating assembly.

However, conventional axial turbines generally lack the ability to perform well at higher expansion ratios, such as are typically needed to harness the pulsing energy of the exhaust of an internal combustion engine.

U.S. Pat. No. 8,468,826 (Kares et al), U.S. Pat. No. 8,353,161; (Kares et al), U.S. Pat. No. 8,769,950 (Lotterman et al); and U.S. Pat. No. 8,453,448 (Lotterman et al) address this problem (see FIG. 1). The turbine housing 8 includes an exhaust gas entrance 3 configured to receive a high-pressure and high-temperature exhaust gas stream T from an exhaust manifold of the engine. The entrance 3 is positioned at the outer circumference of the turbine housing and is oriented to receive flow in a direction tangential to the rotor axis of rotation. The entrance 3 leads to inwardly spiraling scroll or volute 6a, 6b that significantly converges to produce highly accelerated airflow into the turbine at high circumferential angles. Separate volutes 6a, 6b are used for pulse-separation (discussed below). Each volute is wrapped about the circumference of the turbine housing and as the exhaust flows tangentially (circumferentially) the volute also turns the exhaust gas radially inwardly and axially toward the axial turbine wheel, thereby achieving (for some standard operating conditions of the engine) a supersonic flow having both an axial component and a very high-speed circumferential component.

According to US 20140208741 (Svihla et al) (see FIG. 3), although the turbocharger of Lotterman et al. may provide accelerated airflow through the turbine, it directs a non-uniform and poorly guided axial flow through the turbine wheel 1 for wide operating conditions. This poorly guided non-uniform flow may create high energy losses, reduced aerodynamic efficiencies, and increased mechanical or vibrational stresses on the turbine during operation due to flow misalignment (high incidence) with the blades 2 of the turbine at wide operating conditions. Also, the axial turbine stage shown in Lotterman et al. is a high reaction stage, which may lead to supersonic flows with higher aerodynamic losses (passage and secondary flows) in blade passages, as compared to low reaction stages at similar turbine stage loading conditions.

Svihla et al provide a turbocharger with a turbine volute having an inlet 3 configured to tangentially receive exhaust gas from an exhaust manifold of the engine in a purely tangential direction I. In the volute, flow is converted to additionally having axial and radial components, but maintaining an about 45-75 degree tangential component. Exhaust is directed and accelerated towards the blades 2 of an axial turbine wheel I to drive a compressor wheel 4 connected to the turbine wheel by a shaft 5.

However, the turbine of Svihla et al appears to be a low reaction turbine with a large number of blades 2 (see FIG. 3) in comparison to the high reaction turbine of Lotterman et al with a small number of blades 2 (see FIG. 2). This high blade count increases the cost of the turbine wheel.

While it is fundamental to the art to introduce exhaust flow into the turbine housing 8 tangential to the rotor axis, with a spiraling passageway or passageways 6a, 6b designed to supply exhaust flow to the turbine wheel 1 at an inlet 7 with a high-speed circumferential component of flow, the present inventors considered that these circumferential to radial to axial changes in direction of flow combined with the rapid constriction in the spiral and pressure changes required to accelerate flow introduced turbulence, drag, non-uniform flow, and other inefficiencies.

Accordingly, there exists a need for an axial flow turbine improved in ability to harness pulse energy, while having reasonable efficiency both at both lower and higher expansion ratios.

### SUMMARY OF THE INVENTION

The inventors experimented with various strategies for introduction of exhaust gas flow from an engine to a turbine.

As a result of their work, the inventors discovered that a higher efficiency and conservation of energy, and particularly pulse energy, would be achieved if the exhaust flow from an engine was introduced into the turbine housing via multiple runners in a mainly radial direction, i.e., perpendicular and normal to the axis of rotation, with no or very low circumferential or axial component of flow (rather than tangentially, with a large circumferential component of flow, as conventional). Within the turbine housing the substantially radial flow is then redirected in the axial direction either by a curvature in the runners or, preferably, a curvature in the wall of the turbine housing. In addition, the exhaust flow is preferably passed through fixed or variable guide vanes which impart a component of swirl to the flow prior reaching the turbine wheel.

The turbine according to the present invention may be designed as either predominantly impulse or as predominately reaction. In a turbine stage of the impulse type, a pressure drop occurs only in the convergent nozzle guide vane passages. The stream of high velocity gas is directed at the rotor blades where the passages are constant in area and there is no further pressure drop. In a reaction turbine, exactly the opposite takes place. The entire pressure drop takes place between the rotor blades, which have convergent passages. The nozzle (constant area) guide vanes do no more than guide the flow to the rotors. The turbine is driven by the reaction force resulting from the accelerating gas through the convergent passages between the blades (i.e., the space between the blades form nozzles). Preferably, the turbine of the present invention has components of both impulse and reaction.

The present invention thus avoids the cost and expense of designing and producing a conventional turbine housing with an inwardly spiraling volute, with all it's radical changes in flow direction, flow inefficiencies and the rapid constriction required to accelerate flow in the state of the art statorless turbines. The design and manufacture of turbine housings for receiving mainly radial entry runners with no or only some inclination is less complex and thus more economical to manufacture compared to conventional turbine housings. Further, there may be a substantial savings in weight.

### BRIEF DESCRIPTION OF THE DRAWINGS

The present invention is illustrated by way of example and not limitation in the accompanying drawings in which like reference numbers indicate similar parts, and in which:

FIG. 1 depicts a state of the art axial turbine with sector-divided turbine housing according to US 2014/0219790;

FIG. 2 shows a state of the art axial turbine wheel;

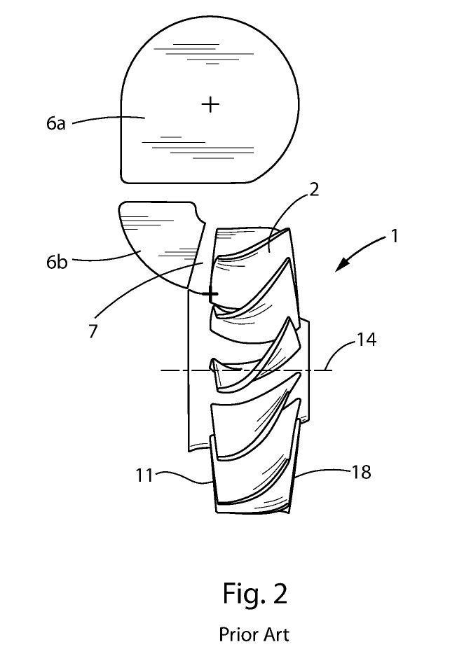

FIG. 3 shows a state of the art axial turbine according to US 2014/0208741;

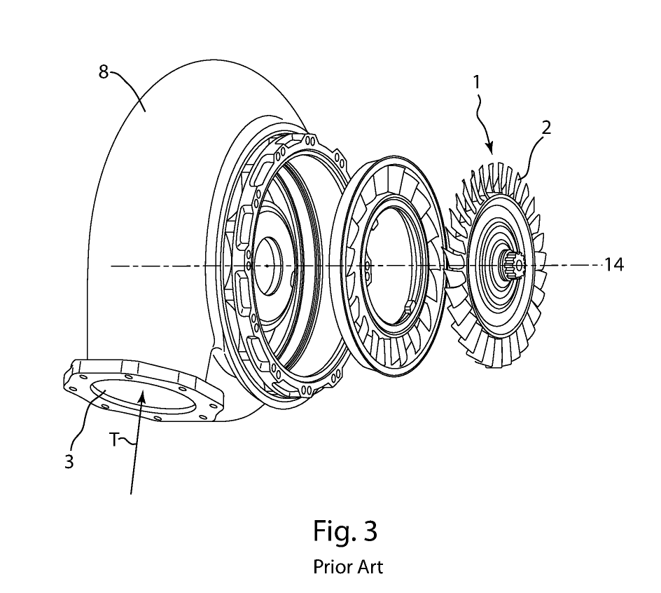

FIG. 4 shows in oblique view a turbine of the present invention, with three runners radially supplying exhaust gas to three circumferential sectors of a turbine, with turbine housing omitted for ease of understanding;

FIG. 5 shows the turbine of FIG. 4 in a front view, with turbine housing removed;

FIG. 6 shows schematically the transition from a radial inflow to an axial outflow, and a guide vane and turbine wheel blade;

FIG. 7 shows a three dimensional representation of the guide vanes and the turbine wheel; and

FIG. 8 shows a flow three-runner in simplified schematic form.

### DETAILED DESCRIPTION OF THE INVENTION

The inventive turbocharger may be driven by exhaust from a four-stroke diesel engine, or may be any other type of combustion engine such as, for example, a two or four-stroke gasoline or gaseous fuel-powered engine. The engine may be three cylinders, multiple of three cylinders (e.g., two banks of three cylinders), or multiples of two cylinders (two, four, six or eight cylinders) or may include a greater or lesser number of cylinders. The cylinders may be arranged in an in-line configuration, in an opposing-piston configuration, in a V-configuration (i.e., a configuration having first and second banks or rows of cylinders) or in another configuration. The turbocharger may be arranged on one side of the engine, or may be nested between two banks of cylinders. For a six cylinder engine, there may be two turbochargers, e.g., one on each side of the engine.

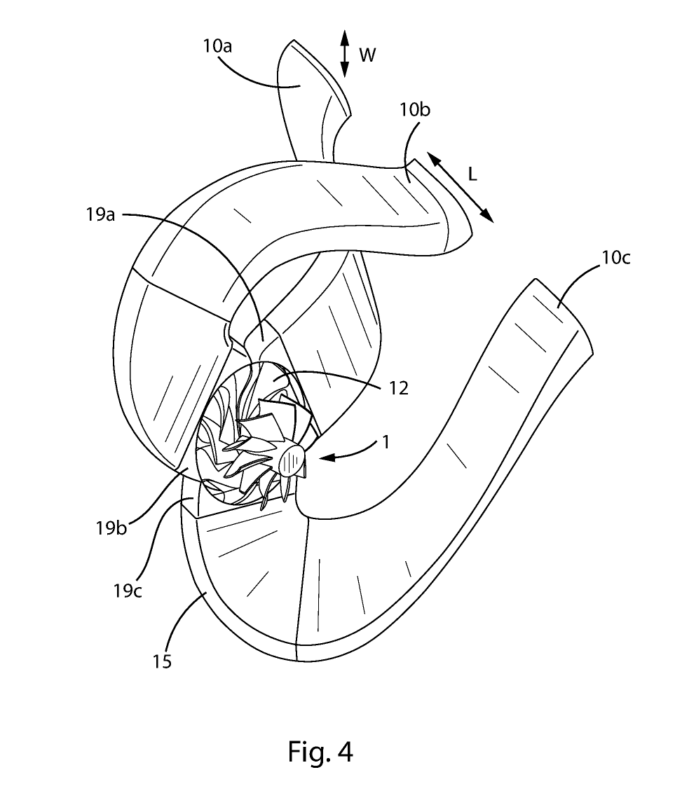

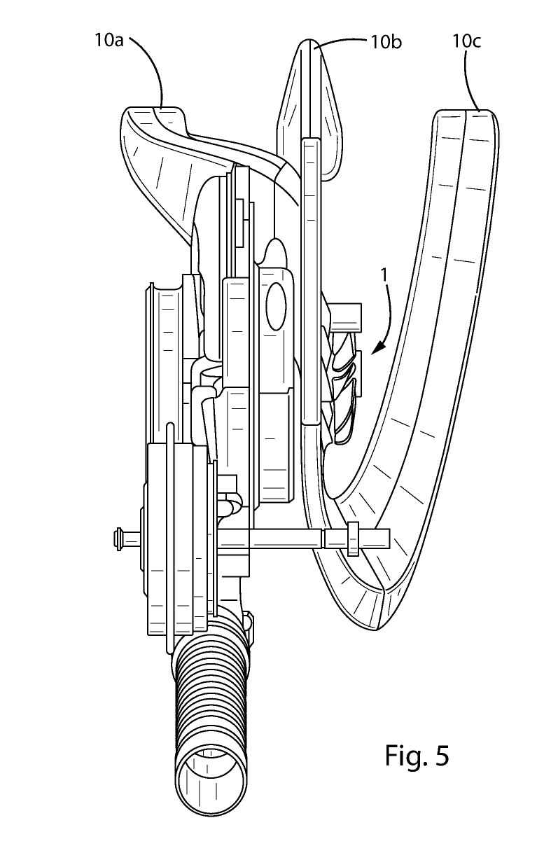

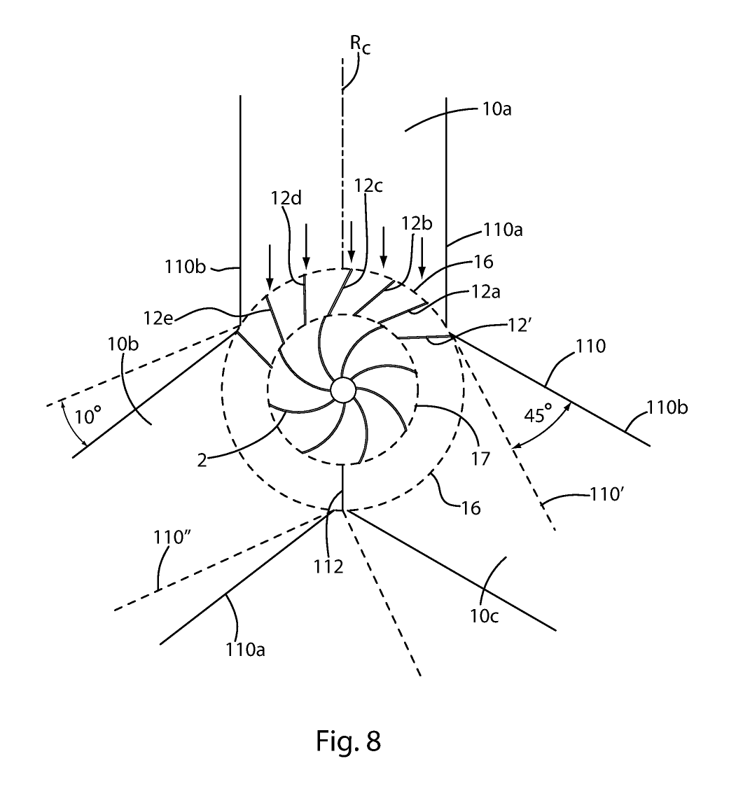

An exhaust system includes runners 19a, 19b, 19c which direct combustion exhaust from the engine to the exhaust gas turbine wheel 1. The first embodiment of the present invention as illustrated in FIGS. 4-7 differs from the prior art structurally most noticeably by dispensing with the complex inwardly spiraling volute(s), and instead employing multiple runners 10a, 10b, 10c to introduce pulse-separated exhaust flow directly to the upstream tips 11 of the turbine blades 2. Each runner 10 feeds a separate exhaust gas stream from one set of cylinders from the internal combustion engine to a different circumferentially separated sector of the turbine. The exhaust flow enters the turbine housing radially, or at least more radially than tangentially, as seen in FIGS. 4 and 8, and guide vanes 12 impart swirl to the exhaust flow. Fixed vanes located in between adjacent runners also maintain pulse separation up to the turbine wheel 1 by maintaining separation of flow between adjacent runners (see FIG. 4).

In an axial flow turbine, exhaust gasses are directed through a turbine wheel in a generally axial direction. While this would suggest that optimal flow efficiency would involve runners feeding exhaust gas from the engine to the turbine axially, this is a problem in the case that the turbine housing 8 is adjacent a bearing housing 13.

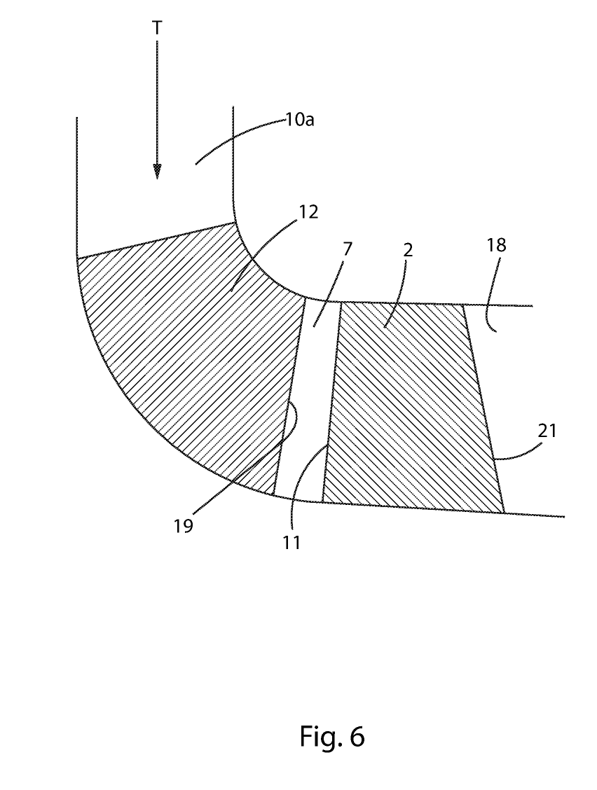

There are two options for introducing exhaust gasses axially into the turbine housing: the streams could be introduced from the bearing housing side to exit on the side away from the bearing housing (first embodiment of the invention), or could be introduced from the side opposite the bearing housing, and exit on the side of the turbine housing adjacent the bearing housing (second embodiment of the invention). In the first embodiment of the invention, axial orientation of the runners (10a, 10b, 10c) is obviously blocked by the presence of the bearing housing 13. Since the bearing housing 13 is indispensable and it's location forms a barrier, according to the first embodiment the runners approach the turbine housing 8 mainly radially (runners with solid lines, FIG. 8), possibly with some tangential component (dash lines, FIG. 8), perpendicular to the axis of rotation 14 of the rotating assembly. At the inlet 7 to the turbine wheel circular space, the direction of flow has been changed to mainly axial via a bend in the runners or turbine housing (FIG. 6). Fixed or moveable guide vanes 12 additionally impart a swirl component to the exhaust gas flow immediately before the exhaust gas impinges on the turbine blades 2. The total efficiency of this design in converting exhaust flow to rotational energy exceeds that of the state of the art designs.

The runners 10a, 10b, 10c are illustrated in the figures as having a substantially rectangular cross-section. The cross-sectional shape of the runners is dependent upon manufacturing preferences, and may be oval, elliptical, circular, or any other desired shape. The runners may be covered with a heat-insulating material to block transmission of heat to the engine compartment, and to deliver exhaust flow with high heat energy content to the turbine wheel.

The expression “exhaust gas inlets oriented substantially radially” as used herein concerns the orientation of the center of flow of the exhaust gas in the runner, as it enters the exhaust gas entrance 3 in the turbine housing, relative to the axis of rotation 14. Each runner may be generally rectangular, or may be round. The flow of gas leaving the runner may be generally laminar. Where the turbine housing contains guide vanes, the runner may terminate upstream of the guide vanes. Alternatively, the guide vanes may be provided in the runners. Further yet, the runners may be cast with the turbine housing including guide vanes as a single piece, or may be provided with fitting pieces or extra segments 15. In the case that the guide vanes are incorporated in the turbine housing, where the runner meets a circle 16 defined by the reach of the upstream edges of the guide vanes 12, which is also where the transition from radial flow to axial and circumferential flow begins. Inside the runners the flow of exhaust gas is linear and parallel across the width of the runner. In the three-cylinder engine embodiment where three runners feed one turbine, each runner may be so wide that it feeds the turbine over 120° of the turbine circumference. The center of flow each runner R_{c} is preferably oriented radial and thus perpendicular to the axis of rotation 14 of the turbine wheel.

The guide vanes 12a-e may by identical to each other, merely circumferentially offset, and exhibiting the same orientation relative to the turbine axis of rotation 14. In FIG. 8 the guide 3 0 vanes are shown stylized as straight lines, but in practice may be complex curves. The guide vanes terminate with a downstream edge 19 forming a circular entrance to the cylindrical space occupied by the turbine wheel blades 2 (and cooperates with but does not extend to the space occupied by the hub 20). The cylindrical space in the turbine housing 8 occupied by the turbine wheel thus begins with an upstream end at the leading edges 11 of the turbine wheel blades 2 and ends with a downstream end at the trailing edges 21 of the turbine wheel blades 2, emptying into an exhaust 18. In the example with three runners, each runner covering 120° of the turbine circumference, there are at least two guide vanes, each about ⅓ of the way across the runner, trisecting the flow of gas. At the contact point of the outer walls of two runners, there is either a dividing wall of the turbine housing extending to the turbine wheel, represented schematically by circle 17, to maintain pulse separation to the turbine blade leading edge, or, preferably, a guide vane identical with the other guide vanes extends from the contact point of the two runners to the turbine blades. In this way, for a three runner system, there will be at least a total of 9 guide vanes. However, the number of guide vanes may be less or may be more, depending upon number of runners and flow pattern. In the illustrative embodiment, five guide vanes 12a, 12b, 12c, 12d, 12e are shown for channeling the flow, and in addition one guide vane 12 or divider wall is provided at the junction of the runners, to illustrate the various angles of incidence if the flow in the runners.

As can be seen in FIG. 8, if all guide vanes were identical but circumferentially offset, and the flow of exhaust gas is laminar, this would result in each guide vane leading edge having a different angle of incidence or exposure to the incoming flow of exhaust gas (arrows, FIG. 8). Guide vane 12a receives flow from near one side wall 110a of the runner 10a at a high angle of incidence. Guide vanes 12b, 12c and 12d receive flow at increasingly smaller angles of incidence. Finally, guide vane 12e receives flow from near the opposite side wall 110b of the runner 10a at a negative angle of incidence. For this reason, in a preferred embodiment of the invention, guide vanes are individually designed with leading edges oriented at an appropriate angle to the direction of flow of the incoming exhaust gas in the runner.

In the preferred embodiment the center of flow of the runner is exactly radial, i.e., perpendicular to the axis of rotation and radial to the axis, and the flow enters the turbine housing with no tangential component of flow. The runners may however also be oriented so that exhaust flow is fed prependicular to the longitudinal axis of rotation but with a tangential component. That is, with the perpendicular center of flow entry discussed above with no tangential offset being referenced as 0° as illustrated by the runners 10a, 10b, 10c with solid lines, the center of flow may be perpendicular to the longitudinal axis (when viewed perpendicular to the axis of rotation) but with a tangential offset (when the line of sight is the axis of rotation) so that the runner side walls 10a, 10b are 0°, or they may be 5°, 10° (dash line runner 110″), 15°, 30° or even as much as 45° (dash line runner 110′) offset so as to impart some tangential i.e. circumferential component to the flow of the exhaust gas before reaching the guide vanes. This way, the work required of the guide vanes may be reduced and efficiency increased.

In the event that the runners are at an angle to impart some tangential or circumferential flow, the guide vanes may be adjusted in orientation or design or number for greatest efficiency.

Even in the case of a 45° offset flow, the exhaust feed of the present invention differs from the prior art in that the runners do not feed into a volute—which is a diminishing scroll around the turbine housing. The inventive runners do not introduce flow via a narrow throat, but rather the runners feed to the entire circumference of the turbine housing, schematically illustrated by circle 16, defined by the leading edges of the guide vanes, each runner feeding a stream of parallel-flow exhaust gas.

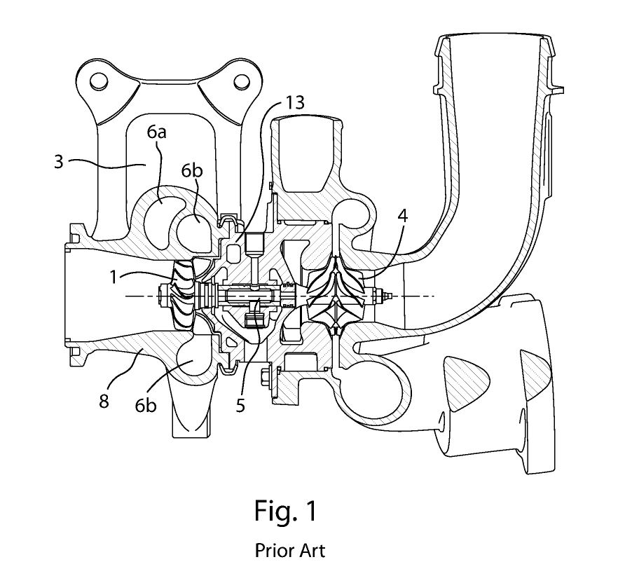

According to US 2014/0219836 (Houst et al) (see FIG. 1), it is known to design the exhaust system in such a manner as to take advantage of the pressure pulsation that occurs in the exhaust stream. In particular, it is known to employ what is known as “pulse separation” wherein the cylinders of the engine are divided into a plurality of subgroups, and the pulses from each subgroup of cylinders are substantially isolated from those of the other subgroups by having independent exhaust passages for each subgroup. To take best advantage of pulse separation, it is desired to minimize the communication or “cross talk” between the separate groups of cylinders.

In a conventional turbine with tangential flow entry, the turbine housing is typically divided into a plurality of substantially separate parts. There are basically two ways in which turbine housings (and more specifically, the volutes of the turbine housings) have been divided: (1) meridional division, and (2) sector division. However, in the inventive turbine housing, as there are no scrolls or volutes, there is no fading of pulse energy as the pulse travels around the circumference of the turbine prior to impacting the turbine wheel blades. In the invention, the pulse, like an ocean wave, flows without interference directly to the guide vanes. Since there is no volute or scroll in which direction is changed and pulse energy defocused as the pulse travels around a spiral, pulse separation is well maintained in the runners. The complex geometry of the meridionally divided or sector divided turbine volute, with associated design and manufacturing complexities, and limited practical application, is dispensed with.

To prevent the various cylinders of a three cylinder engine, or a three cylinder bank of an engine, from interfering with each other and not loosing kinetic energy during the charge exchange cycles, in the illustrated example a single cylinder is connected with each runner. The three runners then allow the exhaust gas flow to be fed separately through the turbine.

In pulse turbocharged commercial diesel engines, twin-entry turbines allow exhaust gas pulsations to be optimized, because a higher turbine pressure ratio is reached in a shorter time. Through the increased pressure ratio, the efficiency increases, improving the all-important time interval when a high, more efficient mass flow is passing through the turbine. As a result of this improved exhaust gas energy utilization, the engine's boost pressure characteristics and, hence, torque behavior is improved, particularly at low engine speeds.

The turbine of the present invention with fully axial turbine wheel can be used for very high pressure ratios. Turbocharging is especially efficient at low end torque conditions, since the pulse from the internal combustion engine is fully delivered to the turbine sections.

In isolated cases, multiple-entry turbines are also used in passenger car petrol engines. The advantages are good torque characteristics at low exhaust backpressure, whereas the dis-advantages have until now been the high thermal load of the dividing wall and the expensive manufacture of the small turbine housings with integral bypass, especially when cast steel is required the housing material because of the high thermal load. With the design of the present invention, using runners with feed separation maintained by guide vanes, the previous disadvantages have been greatly reduced or eliminated.

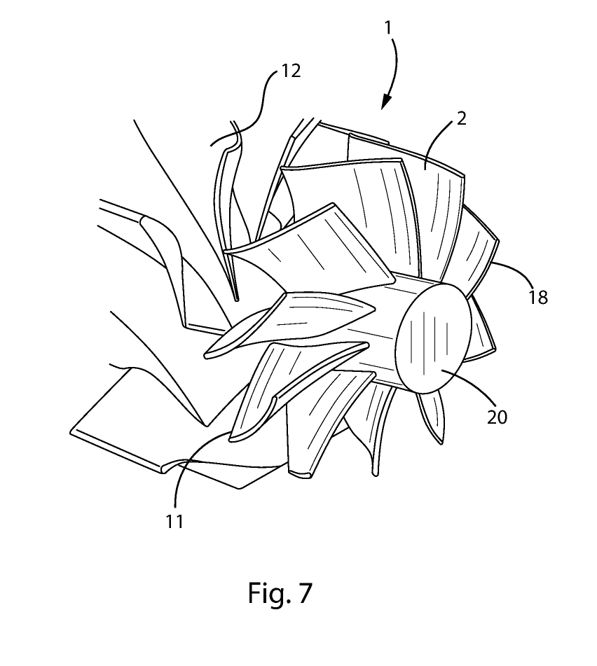

The guide vanes are used to introduce a swirl component upstream of the turbine wheel. The vanes generate sufficient inlet swirl, and some swirl is needed to efficiently extract work from the flow through the rotor blades. Where the conventional tangential entry volute creates sufficient swirl for a radial wheel or axial turbine wheel, and guide vanes as shown in FIGS. 7 and 8 create sufficient swirl for an axial wheel.

The exhaust gas stream becomes a lower total pressure exhaust gas stream while passing through the blades, and is subsequently axially released via a turbine outlet into an exhaust system.

The turbine wheel blades have an axially upstream edge 11, an axially downstream edge 18, and extend radially outward from a central hub 20.

To increase the efficiency of the turbine, the separated runners can be connected by an interaction valve. It may be desirable in some flow conditions to allow cross talk. It may also be desirable to provide a conventional wastegate in one or more of the runners. Then the turbine stage will see full instead of partial admission at cruise conditions, with bypassing the turbine state in the event of excess exhaust flow. A larger turbine can be used for lower engine back pressure at higher engine revolutions (lower charge exchange losses) or to increase the rated power output of the engine.

In the second embodiment of the invention, the runners arrive at the turbine housing from the side opposite the bearing housing (which in the first embodiment is the discharge side), paralleling the axis of rotation of the rotating assembly. The turbine housing includes a circumferentially extending collector chamber adjacent the bearing housing. An exhaust gas outlet is provided to communicate exhaust gasses from the collection chamber to the vehicle exhaust. The outlet may be located virtually anywhere on the collector, so that the outlet may be placed where it is most convenient with respect to the rest of the vehicle engine compartment and exhaust system, thereby further reducing the under hood space required by the turbocharger, and also eliminating at least one of the elbows needed in prior art turbochargers. In operation, the relatively hot exhaust gasses release some of their energy in passing through the turbine blades to impart rotation to the turbine wheel, and are then gathered in the collector chamber. Because some of the energy of the exhaust gasses has been changed from thermal energy to the kinetic energy necessary to rotate the turbine wheel, the exhaust gasses in the collector chamber will be relatively cooler than the exhaust gasses entering the turbine blades at their upstream side. Accordingly, since the gasses in chamber are cooler, they cannot transfer as much thermal energy to the bearings through the wall of the housing. Nevertheless, it may be desirable to provide increased oil cooling between turbine and bearing housing, or to provide a water jacket for cooling.

It should be noted that the system may include multiple turbines arranged in a serial configuration, a parallel configuration, or combination serial/parallel configuration.

The turbine may be a fixed geometry turbine, a variable geometry turbine, or any other type of turbine configured to receive exhaust and convert potential energy in the exhaust to a mechanical rotation.

After exiting the turbine, the exhaust may be discharged to the atmosphere through an aftertreatment system that may include, for example, a hydrocarbon closer, a diesel oxidation catalyst (DOC), a diesel particulate filter (DPF), and/or any other treatment device known in the art.

What is claimed is:

1. A turbocharger turbine housing including a generally cylindrical space for housing an axial turbine wheel (1) having an axis of rotation (14), the turbine housing having multiple exhaust gas supply channels (19a, 19b, 19c), each supply channel having
an inlet oriented to receive flow perpendicular to the axis of rotation (14), and oriented so that said flow is more radial than tangential, and
an outlet oriented to discharge flow into the circular space axially relative to the axis of rotation (14).

2. The turbocharger turbine housing as in claim 1, wherein the outlets of the exhaust gas supply channels (19a, 19b, 19c) are adjacent to the inlet area of the circular space for housing the turbine wheel (1). The turbocharger turbine housing as in claim 1, wherein the flow at the inlet of each exhaust gas supply channel (19a, 19b, 19c) is laminar.

4. The turbocharger turbine housing as in claim 1, wherein each exhaust gas supply channel is oriented to receive flow perpendicular to the axis of rotation (14) and inclined at an angle of between 0° and 45° relative to radial.

5. The turbocharger turbine housing as in claim 1, wherein the angle of inclination of the direction of flow at each exhaust gas supply channel inlet is between 0° and 5° relative to radial.

6. The turbocharger turbine housing as in claim 1, wherein the exhaust gas supply channels include means for introducing a tangential component of flow to the flow entering the circular space.

7. The turbocharger turbine housing as in claim 6, wherein said means for introducing a tangential component of flow is a plurality of fixed guide vanes.

8. The turbocharger turbine housing as in claim 6, wherein said means for introducing a tangential component of flow is a plurality of variable guide vanes.

9. An engine having cylinders and a pulse-driven exhaust-gas-driven turbocharger, and including:
a turbine housing in which an axial turbine wheel is housed in a cylindrical turbine wheel space having an inlet side and an outlet side, the turbine wheel having an axis of rotation, the turbine housing designed to direct exhaust gasses through the turbine wheel in a generally axial direction,
runners (10a, 10b, 10c) separately supplying exhaust gas from one or more cylinders of the engine to different circumferentially separated sectors of the turbine wheel space of the turbocharger, the sectors collectively feeding the entire axial inlet side of the turbine wheel space,
wherein each of the runners introduces exhaust gas from the engine into the turbine housing perpendicular to the axis of rotation of the turbine wheel, and more radial than tangential,
wherein, in a radial-to-axial flow transition section, each of the runners or a back wall of the turbine housing is shaped to transition exhaust gas flow from an inlet direction of flow that is more radial than tangential, to a substantially axial flow,
wherein guide vanes are positioned in the transition section, the guide vanes shaped to impart a swirl component to the exhaust gas flow,
wherein at least some of the guide vanes are positioned at the junctions of runners, to maintain pressure pulse separation by substantially isolating exhaust flow of adjacent runners up to the turbine wheel.

10. The engine according to claim 9, wherein the turbocharger includes a bearing housing adjacent to the turbine housing, and wherein the axial flow flows through the turbine away from the bearing housing.

11. The engine according to claim 9, wherein the turbocharger includes a bearing housing adjacent to the turbine housing, and wherein the axial flow flows through the turbine towards the bearing housing.

12. The engine according to claim 9, wherein the number of runners is from 2 to 5.

13. An engine having cylinders and a pulse-driven exhaust-gas-driven turbocharger, and including:
a bearing housing,
a turbine housing adjacent the bearing housing, in which an axial turbine wheel is housed in a cylindrical turbine wheel space having an inlet side and an outlet side, the turbine wheel having an axis of rotation, the turbine housing designed to direct exhaust gasses through the turbine wheel in a generally axial direction, the turbine housing including a circumferentially extending collector chamber for collecting exhaust adjacent the bearing housing,
runners (10a, 10b, 10c) separately supplying exhaust gas from one or more cylinders of the engine to different circumferentially separated sectors of the turbine wheel space of the turbocharger, the sectors collectively feeding the entire axial inlet side of the turbine wheel space, wherein each of the runners introduces exhaust gas from the engine into the turbine housing axially,
wherein, in the collector chamber, exhaust flow axially exiting the turbine wheel space is changed in direction from axial to radial, is collected, and is guided away from the turbocharger to a vehicle exhaust.
